(19) United States
(12) Patent Application Publication
(10) Pub. No.: US 2012/0227103 A1
(43) Pub. Date: Sep. 6, 2012

(54) INFORMATION PROCESSING APPARATUS AND INFORMATION PROCESSING METHOD

(75) Inventors: Yuya Itagaki, Shizuoka (JP); Yasuhiko Mochida, Shizuoka (JP); Shigeaki Suzuki, Shizuoka (JP)

(73) Assignee: TOSHIBA TEC KABUSHIKI KAISHA, TOKYO (JP)

(21) Appl. No.: 13/398,960

(22) Filed: Feb. 17, 2012

(30) Foreign Application Priority Data
Mar. 4, 2011 (JP) 2011-047846

(51) Int. Cl. G06F 21/04

(52) U.S. Cl. 726/16

(57) ABSTRACT

An information processing apparatus disposed on a shopping cart, comprises a display section; an input section; a position acquiring section of the shopping; a detecting section configured to detect the moving or the stopping of the shopping cart; a counting section configured to count a duration time of the stop state of the shopping cart while the detecting section detects the stopping of the shopping cart; an operation-lock control section configured to read a standby time and limit the display operation of the display section and the accepting operation of the input section.

### CROSS-REFERENCE TO RELATED APPLICATION

This application is based upon and claims the benefit of priority from Japanese Patent Application No. 2011-047846, filed Mar. 4, 2011, the entire contents of which are incorporated herein by reference.

### FIELD

Embodiments described herein relate to an information processing apparatus and an information processing method.

### BACKGROUND

At present, there is a technology in which an information processing apparatus with a display device is mounted on a shopping cart used in a shop such as a supermarket and a shopping mall and enables the display device to display commodity information, guidance of the shop, etc.

### DESCRIPTION OF THE DRAWINGS

FIG. 1 is a view briefly showing the whole constitution of a sales support system according to an embodiment;

FIG. 2 is a view showing the constitution of a cart terminal shown in FIG. 1;

FIG. 3 is a diagram showing an example of data items forming a commodity master table shown in FIG. 2;

FIG. 4 is a schematic diagram showing an example of an internal map data of a shop shown in FIG. 2;

FIG. 5 is a schematic diagram showing an example of the data constitution of an operation and lock controlling table shown in FIG. 2;

FIG. 6 is a flowchart showing the sequence of the UI (user interface) providing processing executed by a cart terminal;

FIG. 7 is a diagram showing an example of a lending registration screen;

FIG. 8 is a diagram showing an example of a purchase support screen;

FIG. 9 is a diagram showing an example of a shop guide screen;

FIG. 10 is a diagram showing the other display forms of the purchase support screen and the shop guide screen;

FIG. 11 is a flowchart showing the sequence of operation-lock control processing executed by the cart terminal; and

FIG. 12 is a diagram showing an example of an operation-lock cancel screen.

### DETAILED DESCRIPTION

According to one embodiment, an information processing apparatus disposed on a shopping cart comprises a display section, an input section configured to receive an operation input, a position acquiring section configured to acquire position information representing the current location of the information processing apparatus disposed on the shopping cart in a region within which the shopping cart is used, a detecting section configured to detect moving or stopping of the shopping cart, a counting section configured to count a duration time of the stop state of the shopping cart While the detecting section detects the stopping of the shopping cart, and an operation-lock control section configured to read a standby time corresponding to the current location of the information processing apparatus from a table in which each position within the region is associated with a standby time in each position and limit the display operation of the display section and the receiving operation of the input section if the duration time reaches the standby time.

The embodiments of the information processing apparatus and the information processing method will be described in detail with reference to the accompanying drawings. The present invention is not limited by the following illustrated embodiments.

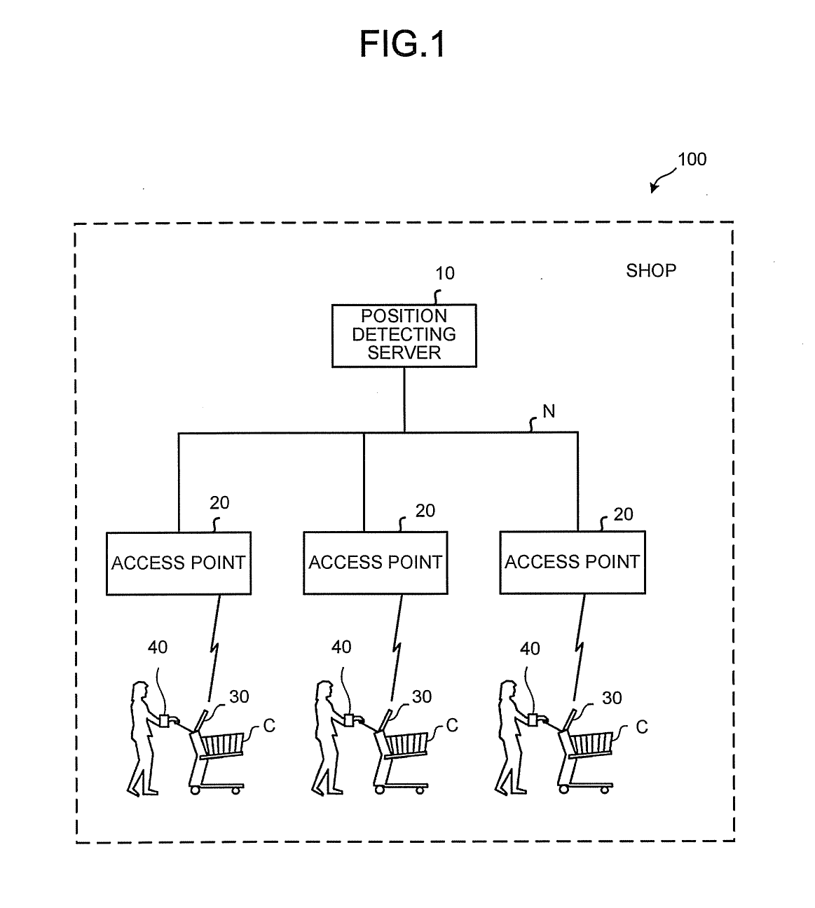

FIG. 1 is a diagram showing the whole constitution of a sales support system 100 according to an embodiment. As shown in FIG. 1, the sales support system 100 comprises a position detecting server 10, an access point 20, a cart terminal 30 and a wireless device 40. Herein, the detecting server 10, the access point 20 and the cart terminal 30 are disposed in a shop such as a supermarket, a shopping mall, a discount store and the like and are connected with one another through a network N such as a wired LAN (local area network), a wireless LAN, etc.

The position detecting server 10 is a server device configured to detect the current position of each cart C (the cart terminal 30) in the shop and transmit the position information showing the detected position to each corresponding cart terminal 30. Furthermore, the position detecting method of each cart C is not particularly limited and can use a well-known and common technology relating to the position detection.

For example, the position of each cart terminal 30 can be detected by an indoor GPS (global positioning system) technology. Furthermore, the configuration position of each access point 22 can be detected as the current position of the cart terminal 30 which accesses to the access points 22 in case that a plurality of access points 22 are disposed at each place in the shop. Furthermore, an RFID (radio frequency identification) tag is attached on the cart C and a plurality of network equipments (not shown) with a tag reading function are disposed at each place in the shop. And then, the configuration position of the network equipment which reads the RFID tag of the cart C is detected as the current position of the cart C.

The access point 20 is a wireless network device used for connecting the network N with the cart terminal 30. The number of access points 20 disposed in the shop is not particularly limited, for example, the access point 20 is disposed at each position which is taken as an important position for the location detection in the shop in case that the present position of each cart C is detected by using the configuration position of the access point 20. Furthermore, FIG. 1 shows an example where one access point 20 is connected with one cart terminal 30, however, the number of cart terminals 30 connected with the access point 20 is not particularly limited.

The cart terminal 30 is an information terminal installed on the shopping cart (cart C) used for purchasing commodities in the shop to provide various UIs (User Interface) which assist the customer in purchasing commodities. The cart terminal 30 obtains the current position of the terminal thereof in the shop via the co-movement with the position detecting server 10, i.e. the current position of the cart 10 with the terminal, and displays the current position together with a map in the shop. The constitution of the cart terminal 30 will be illustrated in the following.

The wireless device 40 is a portable wireless device with the technologies such as the RFID, the Bluetooth (registered trademark), or the ZigBee (registered trademark) and the like, which is owned or carried by the customer who comes to the shop or lent to the customer from the shop. The wireless device 40 stores beforehand identification information (such as a serial number and the like) for identifying each wireless device 40 in a storage medium which is not shown in the figures.

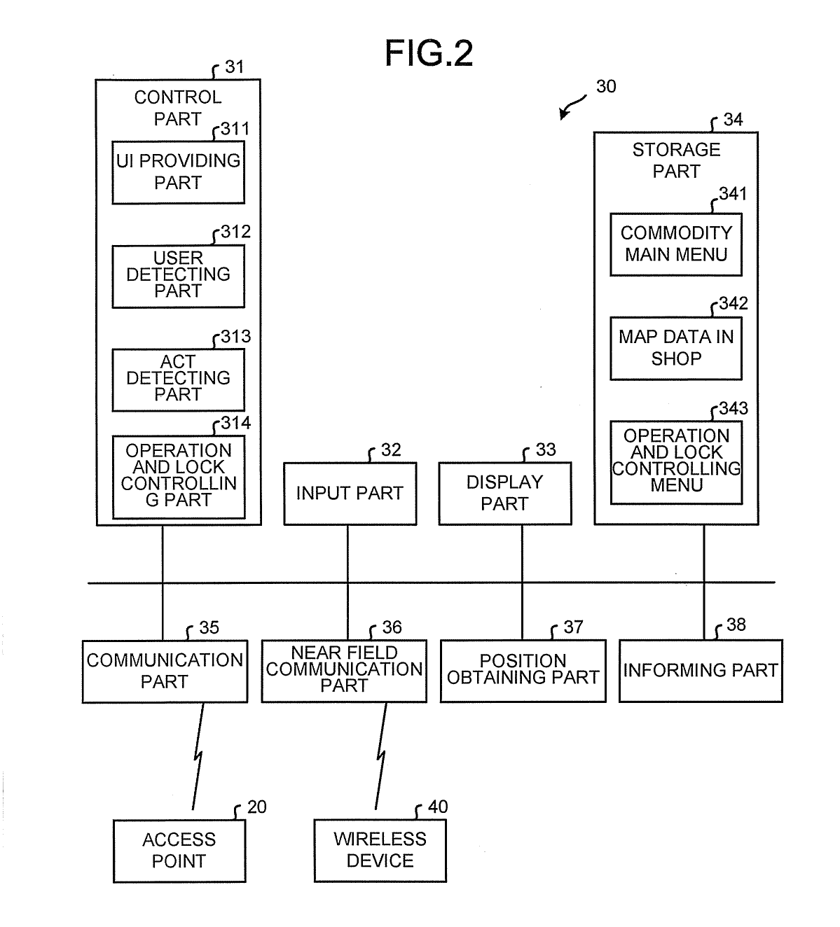

And then, the constitution of the cart terminal 30 is illustrated with reference to FIG. 2. FIG. 2 is a diagram showing the constitution of a cart terminal 30. As shown in FIG. 2, the cart terminal 30 comprises a control section 31, an input section 32, a display section 33, a storage section 22, a communication section 35, a short range communication section 36, a position acquiring section 37 and an informing section 38.

The control section 31 includes a CPU (Central Processing Unit), a ROM (Read Only Memory), a RAM (Random Access Memory) and the like to statistically control the operation of the cart terminal 30 by executing various programs stored in the ROM or the storage section 34 described later.

The input section 32 is an input device such as a keyboard or a pointing device and the like to transmit the operating content of a user to the control section 31. The display section 33 is a display device such as an LCD (Liquid Crystal Display) and the like to display all kinds of information according to the instruction by the control section 31. Furthermore, in this embodiment, for example, the input section 32 is a touch panel, and the input section 32 receives the operating content in cooperation with the UI displayed on the display section 33.

The storage section 34 is a storage medium such as an HDD (Hard Disk Drive) or a flash memory and the like to store various programs and various files executed by the control section 31. Furthermore, the storage section 34 stores not only various files (image date and the like) provided by the UI but also a commodity master table 341, an internal map data in shop 324, an operation-lock control table 343, etc.

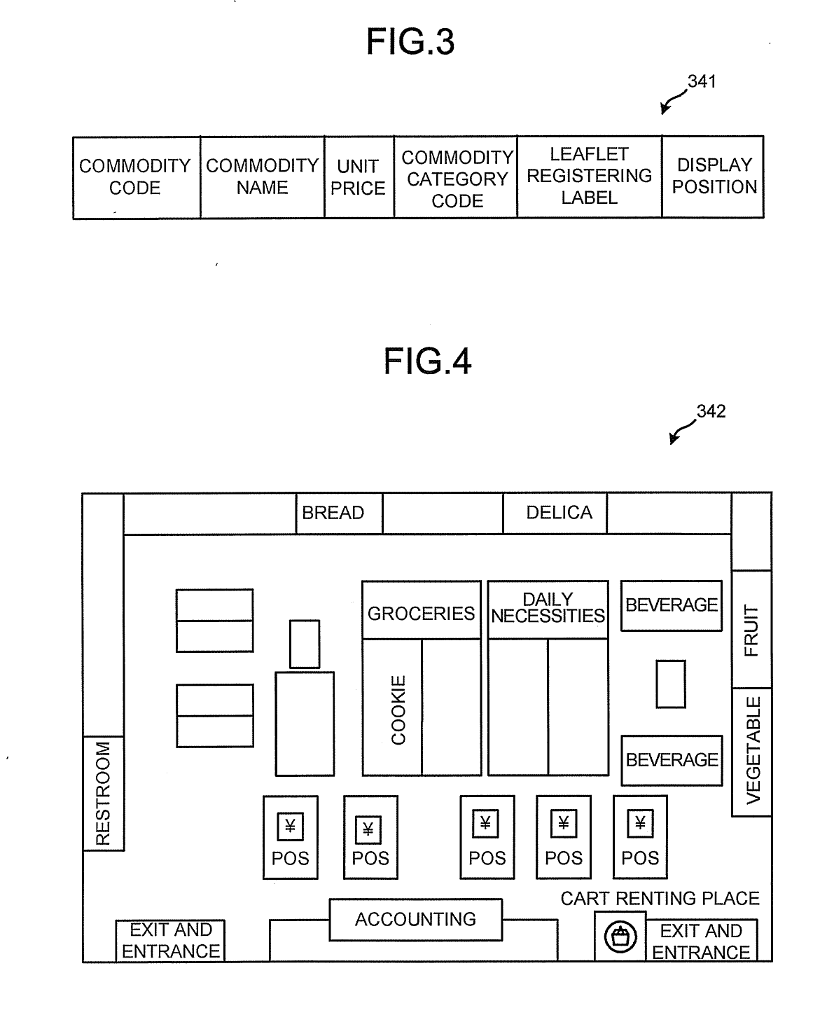

FIG. 3 is a diagram showing an example of data items constituting the commodity master table 341. As shown in FIG. 3, the commodity master table 341 consists of a plurality of records including data items such as a commodity code, a commodity name, a unit price, a commodity category code, a leaflet registration flag, a display position, etc. Herein, the commodity code is a specific code which is preset on each commodity to identify each commodity category sold in the shop. Furthermore, the commodity name, the unit price and the commodity category code are the information relevant to the commodity specified by the same commodity code. The leaflet registration flag is flag information used for identifying whether the commodity specified by the commodity code is registered on an advertisement leaflet of the shop. The display position is the information of the display position of the commodity in the shop indicated by a shelf code or a coordinate, etc.

FIG. 4 is a schematic diagram showing an example of an internal map data of the shop 342. As shown in FIG. 2, the internal map data in shop 342 shows the image data of an internal map in shop (the schematic diagram) formed by simulating the structure of the real shop. The coordinate indicating each position of the real shop and the shelf code indicating each shelf arranged in the shop are added to the internal map data of shop 342 as information which corresponds to (matches) each position in the real shop.

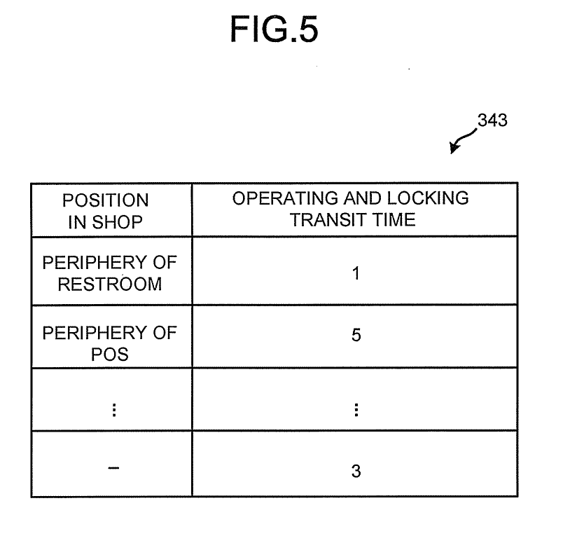

FIG. 5 is a schematic diagram showing an example of the data constitution of an operation-lock control table 343. As shown in FIG. 5, the operation-lock control table 343 stores the ‘position in the shop’ showing each position in the shop and the ‘operation-lock transit time’ showing the standby time for limiting (locking) the operation of the cart terminal 30 in association with one the other. In the example shown in FIG. 5, the operation-lock transit time at the periphery of a restroom is set to be 1 min., and the operation-lock transit time at the periphery of a POS (point-of-sale) terminal is set to be 5 min. Furthermore, ‘-’ as shown at the end of the position in the shop represents a region in the shop other than the position (such as the periphery of the restroom, the periphery of a POS terminal . . . ) in the shop, wherein the operation-lock transit time is set to be 3 min.

FIG. 5 shows an example in which a specific region (such as the periphery of the restroom and the like) in the shop is set as the position in the shop, however, it is not limited to the above, and a specific position may also be appointed. Furthermore, FIG. 5 shows an example in which the operation-lock transit time is set to all regions in the shop, however, it is not limited to the above, and the operation-lock transit time may be set to some regions in the shop.

Returning to FIG. 2, the communication section 35 is a communication interface for executing the data communication with the position detecting server 10 connected with the network N through the access point 20. The short range communication section 36 is a communication interface for executing a short distance communication with the wireless device 40 near the cart C (the cart terminal 30) in a wireless way.

The position acquiring section 37 is a function unit for acquiring the position information of the cart C (the cart terminal 30) on which the section 37 is mounted in cooperation with the position detecting server 10. Specifically, the position acquiring section 37 accesses to the position detecting server 10 through the communication section 35, and acquires (receives) the current position of the cart 10, on which the position acquiring section 37 is mounted, detected by the position detecting server 10 as a position information.

Furthermore, in the embodiment, the position information is acquired in cooperation with the position detecting device 10, however, it is not limited to the above, and the position detecting server 10 is not needed under the circumstance that the current position of the cart terminal 30 can be independently detected by the cart terminal 30. For example, incase that the RFID tag which stores the position information indicating the position thereof is positioned at each position in the shop and a reader device for reading the RFID tag is provided as the position acquiring section 37, the position detecting server 10 is not needed by using the position information acquired from the RFID tag.

The informing section 38 is an informing device for informing occurrence of abnormality and is composed of a audio generation device such as a buzzer or a lighting device such as a lamp, etc. The informing section 38 does not need to be integrally configured with the cart terminal 30 and can be disposed on the optional position of the cart C.

And then, the functional constitution of the cart terminal 30 is illustrated. As shown in FIG. 2, a control section 31 (CPU) of the cart terminal 30 realizes a UI providing section 311, a user detecting section 312, an action detecting section 313 and an operation-lock control section 314 in cooperation with the program stored in the ROM (not shown) or the storage section 34.

The UI providing section 311 is a function section configured to provide various user interfaces relevant to the commodity purchasing in the shop. For example, the UI providing section 311 provides the UI used for listing the commodities to be purchased based on the commodities soled in the shop. Furthermore, the UI providing section 311 displays the current position of the cart terminal 30 (the cart C) equipped with the UI providing section 311 in the shop or displays the displaying position of the commodities to be purchased based on the position information acquired by the position acquiring section 37. Furthermore, the UI providing section 311 further provides a registration screen when the cart C is lent, and a screen for canceling the following operation-lock. Screen example displayed by the UI providing section 311 will be illustrated.

The user detecting section 312 is a function section configured to periodically or constantly read the identification information from the wireless device 40 of the customer who uses the cart C via the short range communication section 36 and judge whether the identification information coincides with the identification information registered when the cart C is lent.

The action detecting section 313 is a function section configured to detect the action of the cart C itself and the action to the cart terminal 30. Specifically, the action detecting section 313 detects whether the cart C is moving and whether the cart terminal 30 is operated. A method for detecting movement of the cart C is not particularly limited and can adopt various forms. For example, in the case that the cart C is equipped with a rotation sensor for mechanically detecting rotation of wheels of the cart C, it can detect whether or not the cart C is moving by monitoring the value of a rotation sensor. Furthermore, in the case in which the cart C is equipped with an acceleration sensor such as a three axels, it can detect whether or not the cart C is moving by monitoring the value of the acceleration sensor. Still furthermore, it can detect whether or not the cart C is moving according to the variable quantity of each unit time of the position information obtained by the position acquiring section 37. The method for detecting the operation of the cart terminal 30 is that it can detect whether or not the cart terminal 30 is operating by monitoring whether or not the input section 32 is operated.

The operation-lock control section 314 is a function section configured to execute the following processing, i.e. limiting the operation to the input section 32 and the user interface (hereinafter referred to as an operation-lock) provided by the UI providing section 311 based on a detecting results of the user detecting section 312 and the action detecting section 313.

Specifically, the operation-lock control section 314 determines that the wireless device 40 is not normally identified in case that the user detecting section 312 detects that the wireless device 40 is unable to be read or the identification information is inconsistent, and switches a transit condition to the operation-lock according to the detecting result of the action detecting section 313. Herein, in the case that the action detecting section 313 detects the movement of the cart C or the operation of the cart terminal 30, the operation-lock control section 314 immediately executes the operation-lock since there is a possibility that the cart C is moved or the cart terminal 30 is operated by a third party except the customer (the user) who borrows the cart C.

On the other hand, in the case that the action detecting section 313 detects that the cart C is stopped and the cart terminal 30 is not operated for a time (hereinafter referred to as a stop state), the operation-lock control section 314 does not immediately execute the operation-lock since there is a possibility that the cart C is temporarily stopped and then the operation-lock control section 314 executes the operation-lock after waiting for the operation-lock transit time which corresponds to the current position of the cart C (the cart terminal 30).

For example, in the operation-lock control table 343 shown in FIG. 5, the operation-lock control section 314 executes the operation-lock after 1 (one) minute is elapsed, if the action detecting section 313 detects the stop state of the cart C when the cart C exists at the periphery of the restroom. Furthermore, the operation-lock control section 314 executes the operation-lock after 5 (five) minute is elapsed, if the action detecting section 313 detects the stop state of the cart C when the cart C exists at the periphery of the POS terminal. Furthermore, the operation-lock control section 314 executes the operation-lock after 3 (three) minute is elapsed, if the action detecting section 313 detects the stop state of the cart C when the cart C exists at regions other than the periphery of the restroom and the periphery of the POS terminal. Herein, the reason why the operation-lock transit time at the periphery of the restroom is set to be shorter than that at the other regions is based on the urgent matter in view of the security such that the customer enters into the restroom and thus the cart C is stopped in the vicinity of the restroom where the customer cannot reach. Therefore, it is preferable that the operation-lock transit time is optimally adjusted according to the condition of facilities disposed at each position in the shop.

Furthermore, the operation-lock control section 314 displays screen (the operation-lock cancel screen) which shows a method of canceling the operation-lock by controlling the UI providing section 311 when the operation-lock is executed. In the operation-lock screen, input of the identification information of the wireless device 40 held by the customer is required. The operation-lock control section 314 cancels the operation-lock when the identification information of the user who carries the cart C is input through the short range communication section 36. Furthermore, the operation-lock control section 314 informs the happening of the abnormality via the informing section 38 when movement in a prescribed distance of the cart C is detected under the operation-lock state.

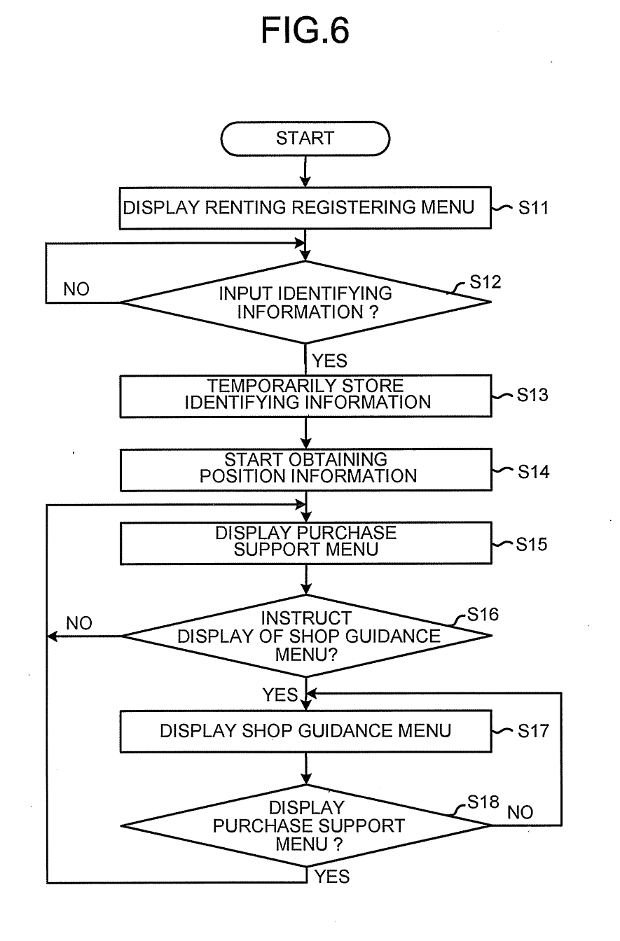

The operation of the cart terminal 30 of the present embodiment is illustrated as follows. Firstly, the processing provided by the UI (hereinafter referred to as a UI providing processing) when using the cart C (the cart terminal 30) is illustrated, as a basic operation, with reference to FIG. 6-FIG. 10.

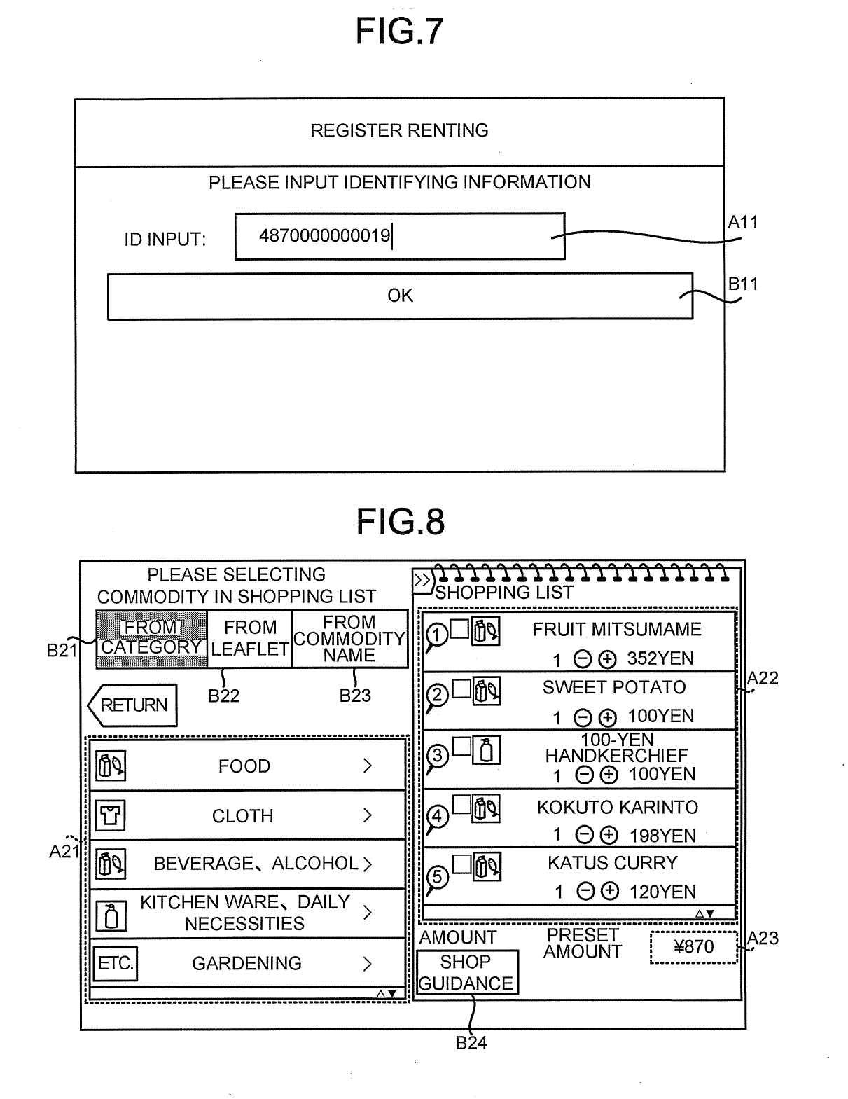

FIG. 6 is a flowchart showing the sequence of the UI providing processing executed by the cart terminal 30. Firstly, the UI providing section 311 displays the lending registration screen for lending the cart C on the display section 33, as shown in FIG. 7 when the cart C is not utilized (not used) (Act 511).

FIG. 7 is a diagram showing an example of a lending registration screen. In FIG. 7, input of the identification information of the wireless device 40 held by the customer who borrows the cart C is required. Furthermore, in FIG. 7, a display region All is a region in which the input identification information is displayed. A button B11 is an operation button for fixing the input identification information.

The UI providing section 311 maintains a standby state until the identification information is input via the short distance communication section 36 (Act S12; No). When the identification information is input (Act S12; Yes), the UI providing section 311 temporarily stores the input identification information in the RAM (not shown) (Act S13). The identification information temporarily stored is taken as a checking information for confirming the identity of the customer in the operation-lock control processing described later.

And then, the UI providing section 311 controls the position acquiring section 37 and thus the position acquiring section 37 begins to acquire the position information (Act S14). Therefore, the position information is periodically or constantly obtained. And then, the UI providing section 311 generates the purchase support screen for supporting the commodity purchase as shown in FIG. 8 based on the commodity master table and displays the purchase support screen on the display 33 (Act S15).

FIG. 8 is a diagram showing an example of the purchase support screen. In FIG. 8, the select item for selecting the commodity to be purchased from the commodities sold in the shop is displayed in a display region A21. The display forms of the select item displayed in the display region A21 are switched according to the pressing of buttons B21-23.

Specifically, when the button B21 is pressed, the UI providing section 311 generates the select item based on the same commodity category code registered in the commodity master table 341 and displays the select item on the display region A21 to provide the UI which enables the customer to select commodities according to the commodity category (such as foods or clothes, etc.). Furthermore, when the button B22 is pressed, the UI providing section 311 generates the select item based on the commodity whose leaflet appearance flag registered in the commodity master table 341 is checked and displays the select item on the display region A21 to provide the UI which enables the customer to select commodities appeared on the leaflet. Still furthermore, when the button B23 is pressed, the UI providing section 311 generates the select item based on the commodity name registered in the commodity master table 341 to provide the UI which enables the customer to select commodities sold in the shop according to the commodity name.

Every time that the commodity in the display region A21 is selected, the UI providing section 311 keeps the commodity name, the unit price, and the number of commodities to be purchased and displays the selected commodity in the display region A22 in a listing way. Herein, the commodity list displayed in the display region A22 is identical with the list of the commodity to be purchased (purchase-planned commodity) by the customer. Therefore, the customer who uses the cart C goes shopping based on the commodity list of the display region A22, and thus is able to avoid missing the commodity to be purchased. The code which is attached on each commodity indicates the order of the commodities selected in the display region A22, wherein the code corresponds to the code in the following shop guide screen.

Furthermore, the UI providing section 311 calculates total amount of money (cash amount to be paid) based on the unit price and the number of commodities to be purchased displayed in the display region A22 and displays the total amount of money in the display region A23, as an amount of money to be paid. Moreover, in FIG. 8, the button B24 is an operation button used for instructing the display of the following shop guide screen.

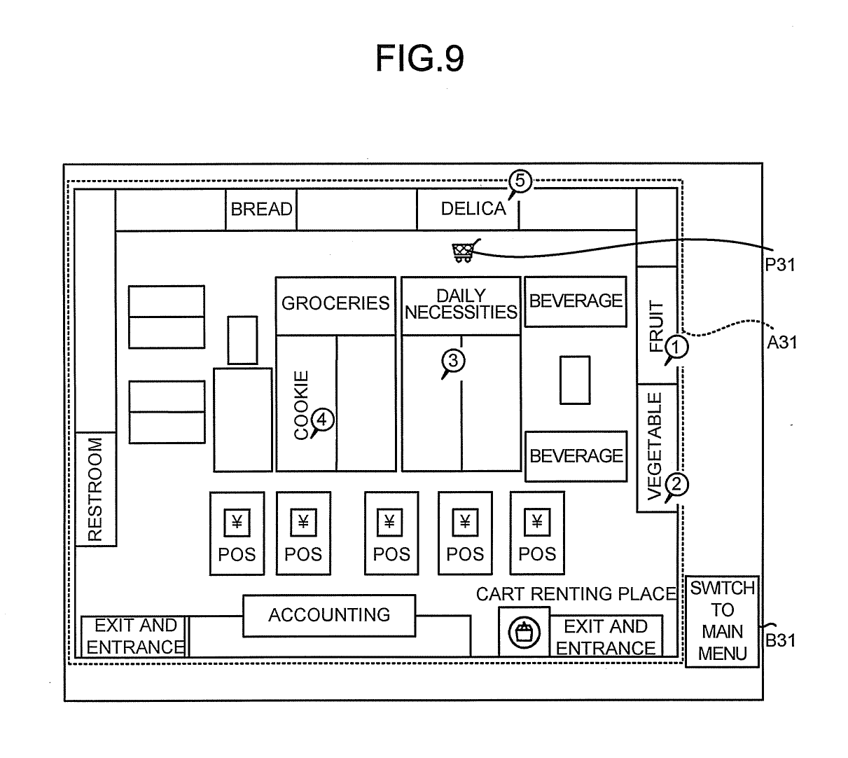

Returning to FIG. 6, the UI providing section 311 judges whether or not the display of the shop guide screen showing the internal map in the shop is instructed during display of the purchase support screen (Act S16). If the display of the shop guide screen is not instructed (Act S16; No), the UI providing section 311 returns to the Act S15 and continuously displays the purchase support screen. On the other hand, in Act S16, if it is determined that the button B24 shown in FIG. 8 is pressed and the display of the shop guide screen is instructed (Act S16; Yes), the UI providing section 311 generates the shop guide screen shown in FIG. 9 based on the commodity master table 341 and the internal map data of the shop 342 and displays the shop guide screen on the display section 33 (Act S17).

FIG. 9 is a diagram showing example of a shop guide screen. The UI providing section 311 reads the internal map data of the shop 342 and displays it as the internal map of the shop in the display region A31. Furthermore, the UI providing section 311 produces the self-location of the cart C by displaying a cart-shaped icon image P31 at the position on the map according to the position information obtained by the position acquiring section 37. Still moreover, the UI providing section 311 reads the display position of each commodity from the commodity master table 341 in each commodity displayed in the display region A22 in the FIG. 8 and generates the display position on the corresponding position on the map to indicate the display position of the commodity to be purchased. In FIG. 9, the positions of icons of the codes 1-5 displayed on the map in the display region A31 correspond to the display position of each commodity displayed in the list in the display region A22 in FIG. 8. Therefore, the customer who uses the cart C goes shopping while the customer confirms the shop guide screen displayed in the display region A31 and thus commodities to be purchased are smoothly picked up. Besides, in FIG. 9, the button B31 is an operation button used for instructing the display of the purchase support screen shown in FIG. 8.

Returning to FIG. 6, the UI providing section 311 judges whether the display of the purchase support screen is instructed during the display of the shop guide screen (Act S18). The UI providing section 311 returns to Act S17 and continuously displays the shop guide screen if the display of the purchase support screen is not instructed (Act S18; No). On the other hand, in Act S18, if it is determined that the display of the purchase support screen is instructed by pressing the button B31 shown in FIG. 9 (Act S18; Yes), the UI providing section 311 returns to Act S15 again to enable the display section 33 to display the purchase support screen.

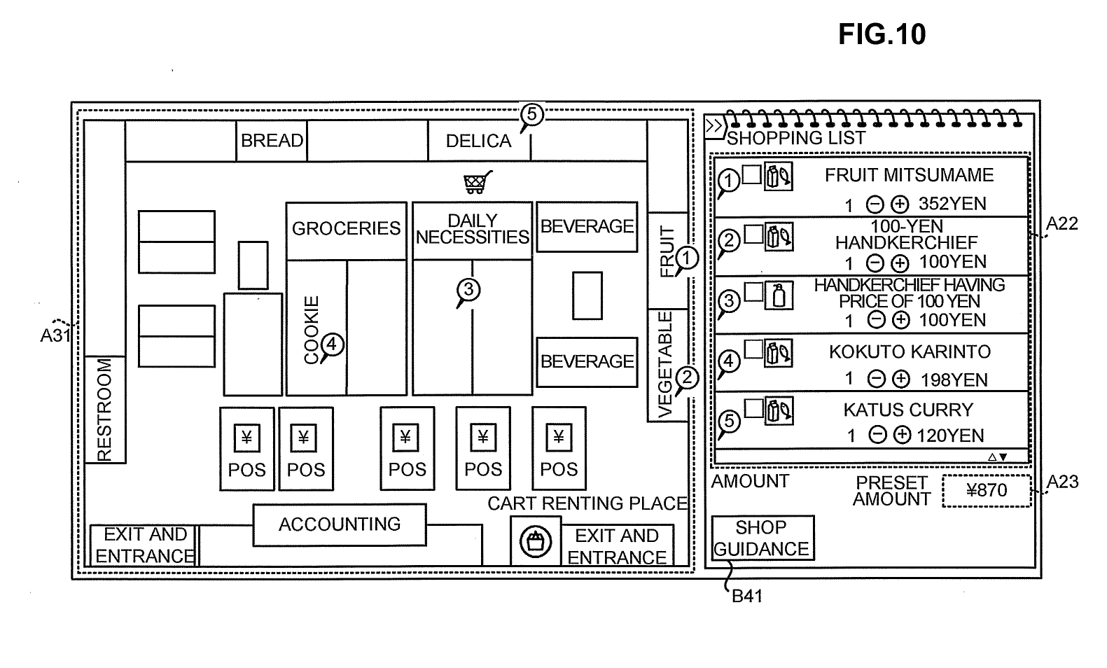

Furthermore, in the present embodiment, the purchase support screen and the shop guide screen are respectively displayed but are not limited to the above, and as shown in FIG. 10, the purchase support screen and the shop guide screen may also be displayed in the same display screen. Furthermore, in FIG. 10, the display is switched over to the purchase support screen as shown in FIG. 8 when the button B41 is pressed.

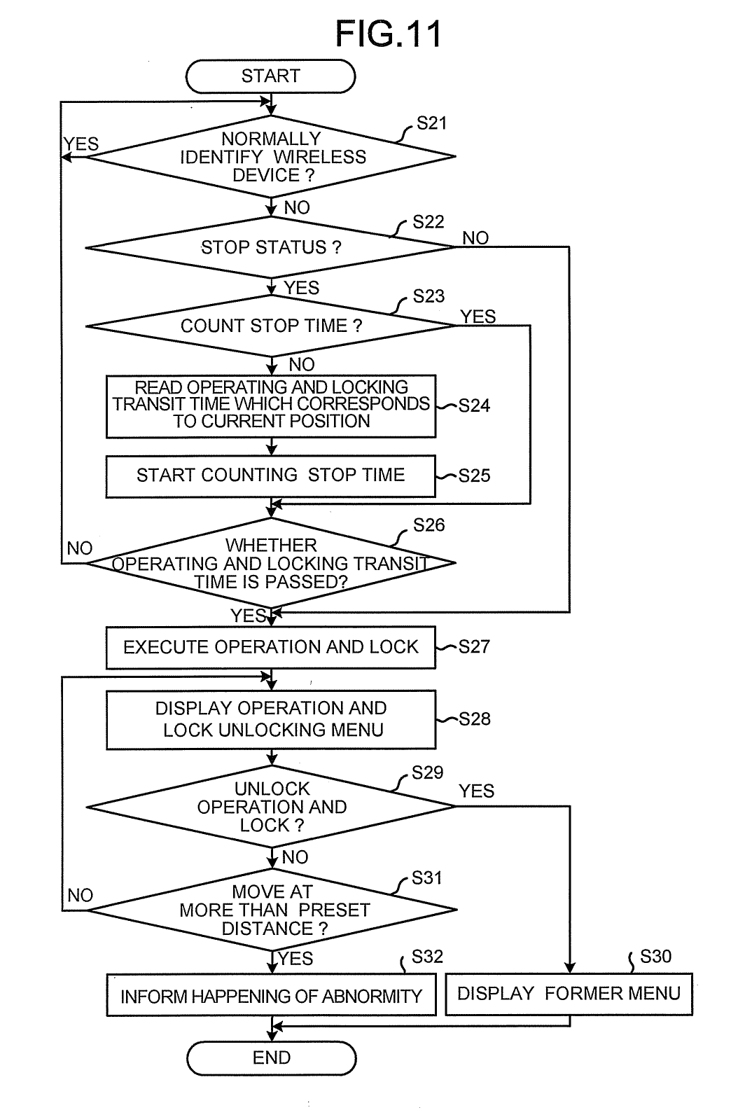

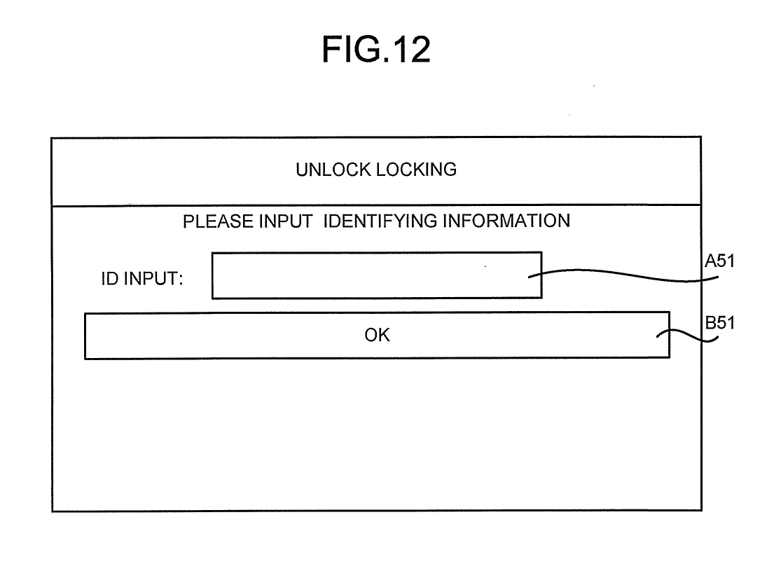

And then, referring to FIG. 11 and FIG. 12, the operation relevant to the operation-lock of the cart terminal 30 is illustrated. FIG. 11 is a flowchart showing a sequence of operation-lock control processing executed by the cart terminal 30. This processing is performed in parallel at a background of the UI providing processing after the registration of the identification information in the above-described UI providing processing (Act S12 and Act S13).

Firstly, the operation-lock control section 314 determines whether or not the wireless device 40 of the user (customer) using the cart C is normally identified based on the detecting result of the user detecting section 312 (Act S21). Herein, the operation-lock control section 314 determines that the wireless device 40 is normally identified (Act S21; Yes) if the user detecting section 312 reads the identification information from the wireless device 40 and confirms that the identification information read is coincident with the checking information (identification information) temporarily stored in the RAM, and the operation-lock control section 314 enters into a standby state until the user detecting section 312 reads identification information from a next wireless device 40.

On the other hand, the user detecting section 312 detects failure of the reading from the wireless device 40 if the user using the cart C goes around apart from the cart C. Besides, the user detecting section 312 detects inconsistency between the identification information and the checking information a third party other than the user using the cart C stands near the cart 10. In such circumstances, the operation-lock control section 314 determines that the wireless device 40 is not normally identified (Act S21; No) and confirms whether the cart C and the cart terminal 30 are stopped (Act S22) based on a detecting result of the action detecting section 313. Herein, Act S27 is directly taken from Act S22 since there is a possibility that a third party except the user using the cart 10 carries the cart C or operates the cart terminal 30 if the action detecting section 313 detects the movement of the cart C or the operation of the cart terminal 30 (Act S22; No).

Therefore, in the present embodiment, whether or not the user of the cart C goes around apart from the cart C and whether or not a third party expect the user of the cart C is in the environment in which she or he can operates the cart Care judged according to the wireless device 40. Therefore, since the operation to the cart terminal 30 is limited according to the situation in which the cart Cis located, the risk in security of the cart C (the cart terminal 30) can be more effectively reduced.

And then, in Act S22, the operation-lock control section 314 judges whether or not the time that the stop state is maintained (hereinafter referred to as a stop time) is being counted (Act S23) if the action detecting section 313 determines that the cart C and the cart terminal 30 are under the stop state (Act S22; Yes).

In the Act S23, the operation-lock control section 314 reads the operation-lock transit time which corresponds to the current position of the cart C (the cart terminal 30) from the operation-lock control table 343 based on the position information acquired by the position acquiring section 37 if the operation-lock control section 314 determines that the stop time is not being counted (Act S23; No). And then, the operation-lock control section 314 starts counting the stop time (Act S25) and Act S26 is taken. Furthermore, in Act S23, Act S26 is directly taken from the Act S23 if the operation-lock control section 314 determines that the stop time is being counted (Act S23; Yes).

In Act S26, the operation-lock control section 314 judges whether the stop time passes the operation-lock transit time (Act S26; No). Herein, Act S21 is taken again if the stop time still does not reach the operation-lock transit time (Act S26; No). In Act S21, the counting of the stop time is stopped and the counting value is reset if the wireless device 40 is normally identified.

In Act S26, Act S27 is taken if it is determined that the stop time passes the operation-lock transit time (Act S26; Yes). The operation-lock control section 314 limits the operation to the input section 32 and executes the operation-lock in which the user interface provided by the UI providing section 311 is limited (Act S27). And then, the operation-lock control section 314 displays the operation-lock cancel screen as shown in FIG. 12 on the display section 33 by controlling the UI providing section 311.

Herein, FIG. 12 is a diagram showing an example of the operation-lock cancel screen. In FIG. 12, input of the identification information of the wireless device 40 held by the customer is required. In FIG. 12, the display region A51 is the region in which the input identification information is displayed. The button B51 is the operation button used for instructing the fixing of the input identification information.

Returning to FIG. 11, the operation-lock control section 314 judges whether or not the cancel of the operation-lock is instructed based on the detecting result of the user detecting section 312 (Act S29). The operation-lock control section 314 determines that the cancel of the operation-lock is instructed (Act S29; Yes), enables the UI providing section 311 to display again the screen displayed before the operation-lock screen is displayed (Act S30), and ends the processing if the user detecting section 312 confirms the coincidence between the checking information (identification information) temporarily stored in the RAM and the identification information input through the short range communication section 36.

In the Act S29, the operation-lock control section 314 judges whether the cart C moves more than a set distance after the operation-lock is executed (Act S31) based on the position information acquired by the position acquiring section 37 if the cancel of the operation-lock is not instructed (Act S29; No). Herein, the Act 28 is taken again if it is determined that the cart C is moved less than the set distance (Act S31; No). On the other hand, the operation-lock control section 314 enables the informing section 38 to inform the occurrence of the abnormality (Act S32) if it is determined that the cart C is moved more than a prescribed distance (Act S31; Yes) and the processing is ended. This is because that there is a possibility that a third party except the user of the cart C moves the cart C.

Therefore, according to the present embodiment, the operation of the cart terminal 30 is limited after waiting for the standby time of the operation-lock transit time corresponding to the place where the cart C locates in case that the user of the cart C goes around apart from the cart C. Therefore, it can avoid that the cart terminal 30 of the cart 30 is operated by a third party while the user of the cart C goes around apart from the cart C, and thus the security of the cart terminal 30 can be improved.

Besides, the operation of the car terminal 30 can be limited if a third party intends to move the cart C by immediately limiting the operation of the cart terminal 30 in case that the wireless device 40 detects the movement of the cart C under the state that the wireless device 40 is not normally identified. Furthermore, in the case in which the cart C is moved more than a prescribed distance while the operation-lock is not canceled, the occurrence of the abnormality is informed by the informing section 38 and thus it can prevent the cart C from being taken away.

The embodiments of the present invention are illustrated by way of examples rather than limiting the range of the present invention. The embodiments can be implemented by various forms, and various omissions, alternatives, changes, supplements and the like can be made without departing from the major idea of the present invention. Furthermore, the embodiments and the variants thereof belong to the range and the major idea of the present invention and belong to the present invention and the equivalents thereof described in the claims.

For example, in the embodiment, the informing section 38 is configured to inform the abnormality but it is not limited to the above. The informing section 38 may also transmit a signal (information) which informs the happening of the abnormality to the position detecting server 10 or the other server device through the communication section 35.

Furthermore, in the embodiment described above, the commodity master table 341, the internal map data in shop 342 and the operation-lock control table 343 are stored in the cart terminal 30 but it is not limited to the above. They may also be stored in an external server (not shown) on the network N to which the cart terminal 30 is accessible.

Still furthermore, in the embodiment, the lending of the cart C and cancel of the operation-lock are executed through the wireless device 40 but it is not limited to the above. The lending of the cart C and cancel of the operation-lock may be executed by inputting the identification information (or proper information such as a name) by the user of the cart C via the input section 32. In such circumstances, in the operation-lock control processing shown in FIG. 11, the processing of the Act S21 is not needed, and the flow of the processing is transferred to the self processing (Act S22) if the movement of the cart C or the operation of the cart C is determined in the judgment of the stop state in the Act S22 (Act S22).

In the embodiment, the stop of the cart C together with the disoperation of the cart terminal is referred to as a stop state but it is not limited to the above. Only the stop of the cart C may be referred to as s stop state and the operation-lock control processing may be executed.

Furthermore, the program executed by each device of the embodiment not only can be provided by the storage medium (the ROM or the storage part) which is previously coded in each device but also can be provided as an installable or executable file which is recorded in the recording medium which can be recorded by the computer such as the CD-ROM (compact disc read-only memory), the flexible disk (FD), the CD-R (compact disk-recordable), the DVD (digital video disk). Furthermore, the storage medium not only can comprise the medium independent from the computer or the assembled system but also can comprise the stored and temporarily stored storage medium by means of loading of the transmitted program such as the LAN (local area network) or the internet, etc.

Furthermore, the program excused by each device of the embodiment can be stored on the computer which is connected with the network such as the Internet to be provided by means of network downloading and can be provided or published by the network such as the Internet, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus disposed on a shopping cart, comprising:
a display section;
an input section configured to accept an operation input;
a position acquiring section configured to acquire position information showing the current location of the information processing apparatus disposed on the shopping cart in a region within which the shopping cart is used;
a detecting section configured to detect the moving or the stopping of the shopping cart;
a counting section configured to count a duration time of the stop state of the shopping cart while the detecting section detects the stopping of the shopping cart; and
an operation-lock control section configured to read a standby time corresponding to the current location of the information processing apparatus from a table in which each position within the region is associated with a standby time in each position, and limit the display operation of the display section and the accepting operation of the input section if the duration time reaches the standby time.

2. The apparatus according to claim 1, further comprising:
an informing section; and
an informing control section configured to enable the informing section to operate if a moving distance of the apparatus derived from the position information reaches a preset distance while operations of the display section and input section are limited.

3. The apparatus according to claim 1, further comprising:
a storage section configured to store identification information as checking information for identifying a user of the cart; wherein
the operation-lock control section cancels the limit if an identification information which coincides with the checking information stored in the storage section is input.

4. The apparatus according to claim 2, further comprising:
a storage section configured to store identification information as checking information for identifying a user of the cart; wherein
the operation-lock control section configured to cancel the limit if the identification information which coincides with the checking information stored in the storage section is input.

5. The apparatus according to claim 3, further comprising:
a reading section configured to read the identification information stored in a wireless device from the wireless device carried by the user of the shopping cart through a short distance communication, wherein
the counting section counts the duration time if the reading unit unsuccessfully reads the identification information or the identification information read by the reading unit is inconsistent with the checking information while the detecting section detects stop of the shopping cart.

6. The apparatus according to claim 5, wherein the operation-lock control section executes the limit of operations of the display section and input section if the reading unit section unsuccessfully reads the identification information or the identification information read by the reading section is inconsistent with the checking information, and the detecting section detects movement of the shopping cart.

7. An information processing method of an information processing apparatus, disposed on a shopping cart, which includes a display unit and an input unit which accepts an operation input, comprising:
obtaining a position information showing the current position of the shopping cart within a region in which the shopping cart is used;
detecting moving or stopping of the shopping cart;
counting the duration time of the stop state of the shopping cart while the detecting unit detects stopping of the shopping chart; and
limiting the display operation of the display unit and the accepting operation of the input unit if the duration time reaches a standby time read from a table in which each position within the region is associated with the standby time in each position.
